(19) United States
(12) Patent Application Publication
(10) Pub. No.: US 2023/0010271 A1
(43) Pub. Date: Jan. 12, 2023

(54) SEAT ASSEMBLY FOR A STANDUP MOTORIZED TRANSPORT UTILITY VEHICLE

(71) Applicant: LyteHorse Labs, Inc., Regina (CA)

(72) Inventors: Allen William BONK, Regina (CA); Bradley James BONK, Regina (CA)

(21) Appl. No.: 17/659,560

(22) Filed: Apr. 18, 2022

Related U.S. Application Data
(60) Provisional application No. 63/218,946, filed on Jul. 7, 2021.

(51) Int. Cl. B60N 2/015; B60N 2/30

(52) U.S. Cl. CPC B60N 2/01558; B60N 2/3097; B60N 2/3009

(57) ABSTRACT

A motorized standup utility vehicle having a removeable seat post assembly. The removeable seat post assembly is substantially cylindrical and has an “S” curvature shape and consists of a top post assembly and a bottom post assembly. The removeable seat post assembly has a pivotable seat on one end and male pin on the other end configured to removably attach to a receiving channel of a seat frame of the utility vehicle. The removable seat post assembly can be configured in a sitting position and a standing position to support the back of a rider.

### CROSS REFERENCE TO RELATED APPLICATIONS

The application claims priority to and the benefit of U.S. Utility Provisional Application Ser. No. 63/218,946, entitled “A GOLF BAG MOUNTING SYSTEM FOR A STANDUP MOTORIZED TRANSPORT UTILITY VEHICLE”, filed on Jul. 7, 2021, which is incorporated herein by reference in its entirety.

### BACKGROUND

The embodiments described herein motorized vehicles, and more particularly to a single-rider, standup electric utility vehicle.

Conventional motorized golf carts having parallel wheels and axles are used to haul golf bags and golf carts. Mounted golf bags have traditionally been mounted in a vertical position on golf carts making club selection slow and sometimes difficult to find. Having to pull the selected club is more awkward than it needs to be.

A new generation of motorized standup vehicles such as the vehicle described in U.S. Utility patent application Ser. No. 17/076,754, entitled “SYSTEM AND METHOD FOR A STANDUP MOTORIZED TRANSPORT UTILITY VEHICLE”, filed on Oct. 21, 2020, which is incorporated herein by reference in its entirety.

Accordingly, there is a desire to implement a vehicle capable of supporting a driver in both standing and sitting position.

### SUMMARY

A motorized standup utility vehicle having a removeable seat post assembly. The removeable seat post assembly is substantially cylindrical and has an “S” curvature shape and consists of a top post assembly and a bottom post assembly. The removeable seat post assembly has a pivotable seat on one end and male pin on the other end configured to removably attach to a receiving channel of a seat frame of the utility vehicle. The removable seat post assembly can be configured in a sitting position and a standing position to support the back of a rider.

### BRIEF DESCRIPTION OF THE DRAWINGS

FIG. 1 is a line drawing of a perspective view of a standup motorized utility vehicle in accordance with certain embodiments of this disclosure.

FIG. 2 is a line drawing of a perspective view of a standup motorized utility vehicle configured with a seat post assembly.

FIG. 3 is a line drawing of a side view of a standup motorized utility vehicle with a rider and a seat post assembly configured in standing position.

FIG. 4 is a line drawing of a side view of a standup motorized utility vehicle with a rider and a seat post assembly configured in sitting position.

FIG. 5 is a photo of a seat post assembly in a motorized utility vehicle in sitting position.

FIG. 6 is a photo of a seat post assembly in a motorized utility vehicle in standing position.

FIG. 7 is a photo of an assembled seat post assembly.

FIG. 8 is a photo of a disassembled seat post assembly.

FIG. 9 is a side view of seat post assembly.

FIG. 10 is a front plan view of seat post assembly.

FIG. 11 is an exploded view of seat post assembly.

FIG. 12 is a perspective view of the bottom post member of the seat post assembly.

FIG. 13 is a perspective view of the top post member of the seat post assembly.

FIG. 14 is a cross-section view of a connection of top post member and bottom post member of the seat post assembly.

FIG. 15 is a line diagram of the connection of the seat post assembly to the standup motorized utility vehicle.

### DETAILED DESCRIPTION

In the following descriptions, the present invention will be explained with reference to various example embodiments; nevertheless, these embodiments are not intended to limit the present invention to any specific example, environment, application, or particular implementation described herein. Therefore, descriptions of these example embodiments are only provided for purpose of illustration rather than to limit the present invention. The invention is to cover all modifications, equivalents, and alternatives falling within the scope of the invention as defined by the appended claims.

The various features or aspects discussed herein can also be combined in additional combinations and embodiments, whether or not explicitly discussed herein, without departing from the scope of the invention.

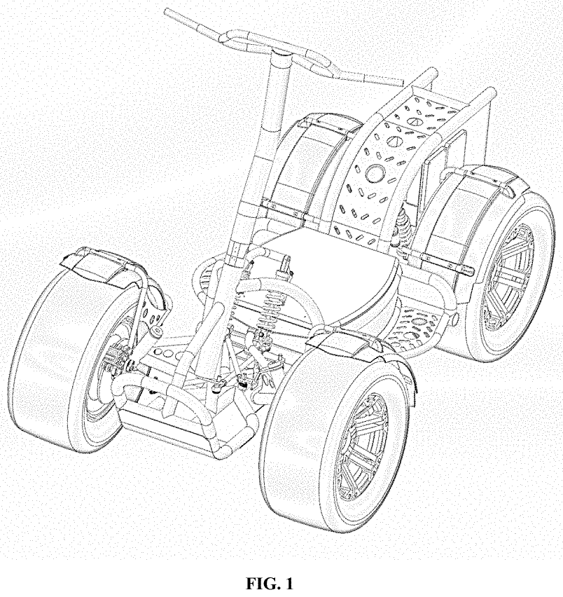

FIG. 1 is a line drawing of a perspective view of a standup motorized utility vehicle in accordance with certain embodiments of this disclosure. According to FIG. 1, the utility vehicle is configured for a single rider to drive the vehicle while in a standing position. More information on a utility vehicle can be further described in U.S. Utility patent application Ser. No. 17/076,754, entitled “SYSTEM AND METHOD FOR A STANDUP MOTORIZED TRANSPORT UTILITY VEHICLE”, filed on Oct. 21, 2020, which is incorporated herein by reference in its entirety.

According to FIG. 1, the dimensions of the utility vehicle include a length of 91⅛ inches, a height of 58 inches, a front wheel width of 47⅝ inches and a rear wheel width of 34 13/16 inches. Of note is a wider front wheel width compared to the rear wheel width to provide better stability and maneuverability.

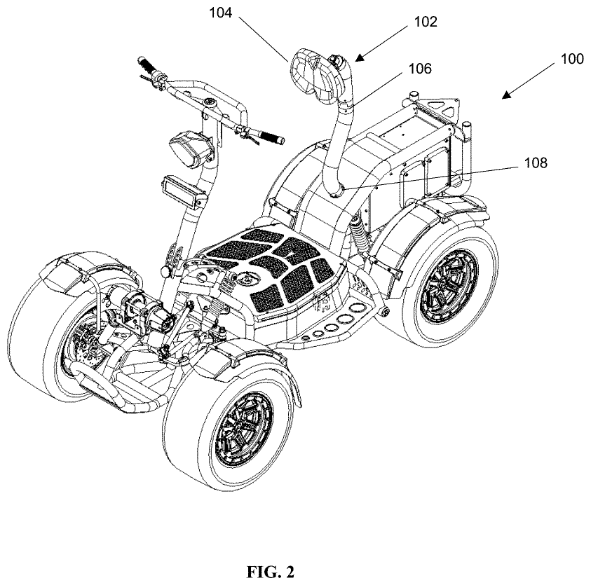

FIG. 2 is a line drawing of a perspective view of a standup motorized utility vehicle configured with a seat post assembly. According to FIG. 2, utility vehicle 100 includes a seat assembly 102 having a seat 104 and seat post 106. Seat 104 can be made of leather, vinyl, foam or other soft seat compatible materials. Seat post 106 is substantially cylindrical and can be made of two or more pieces. Seat post 106 attaches to the utility vehicle through a seat frame connection channel 108.

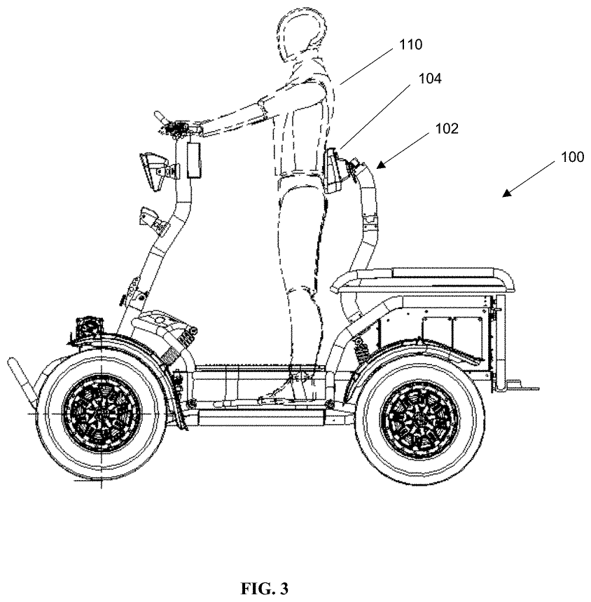

FIG. 3 is a line drawing of a side view of a standup motorized utility vehicle with a rider and a seat post assembly configured in standing position. According to FIG. 3, rider 110 is standing on utility vehicle 100. Seat post assembly 102 is configured in standing position with seat 104 oriented 90 degrees to support the back/lumbar region of the rider. The height of top of the seat 104 to the bottom of the wheel of utility vehicle 100 is approximately 58″. In further embodiments, a belt or seat belt may be configured to wrap around the rider around seat 104 to provide further protection and safety.

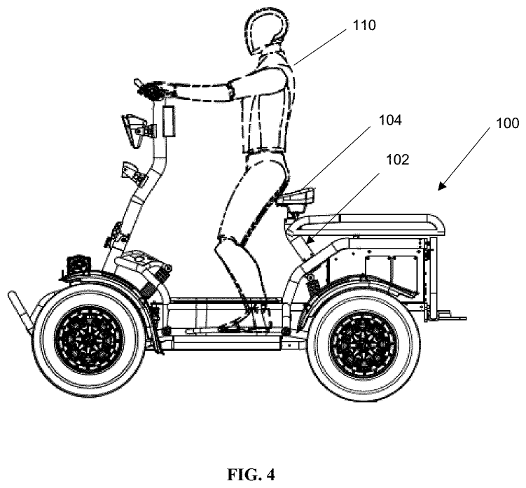

FIG. 4 is a line drawing of a side view of a standup motorized utility vehicle with a rider and a seat post assembly configured in sitting position. According to FIG. 4, rider 110 is sitting on utility vehicle 100. Seat post assembly 102 is configured in sitting position with seat 104 oriented 180 degrees to support the buttock of the rider 110. The height of top of the seat 104 to the bottom of the wheel of utility vehicle 100 is approximately 52⅝″.

Furthermore, seat post assembly 102 is disassembled to use a lower post of the seat post assembly in seated position. The other piece(s) of the seat post assembly can be stored on the utility vehicle 100 for use when in standing position. In further embodiments, seat post assembly can be configured as a telescopic design that can extend to a longer standing position and retract to a shorter sitting position.

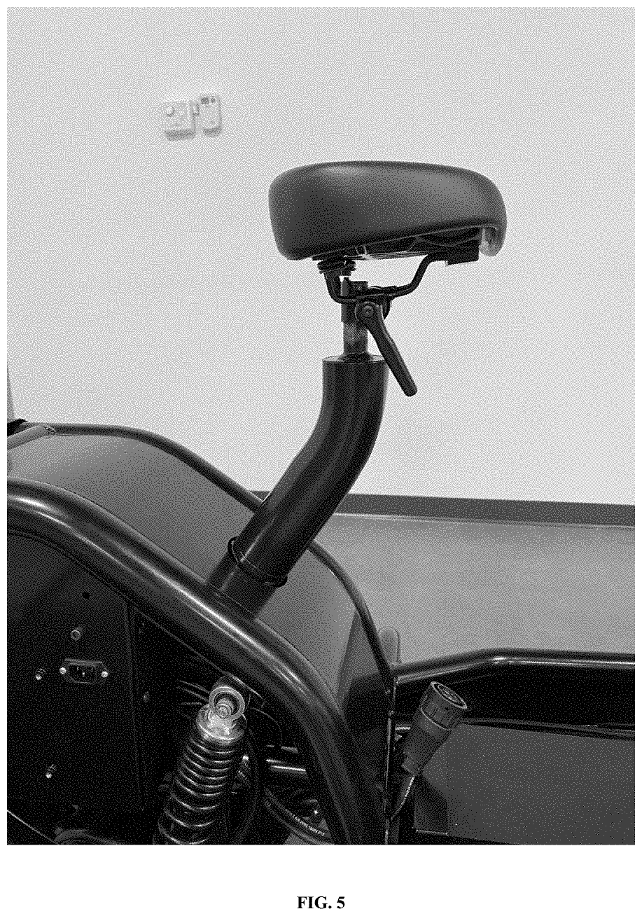

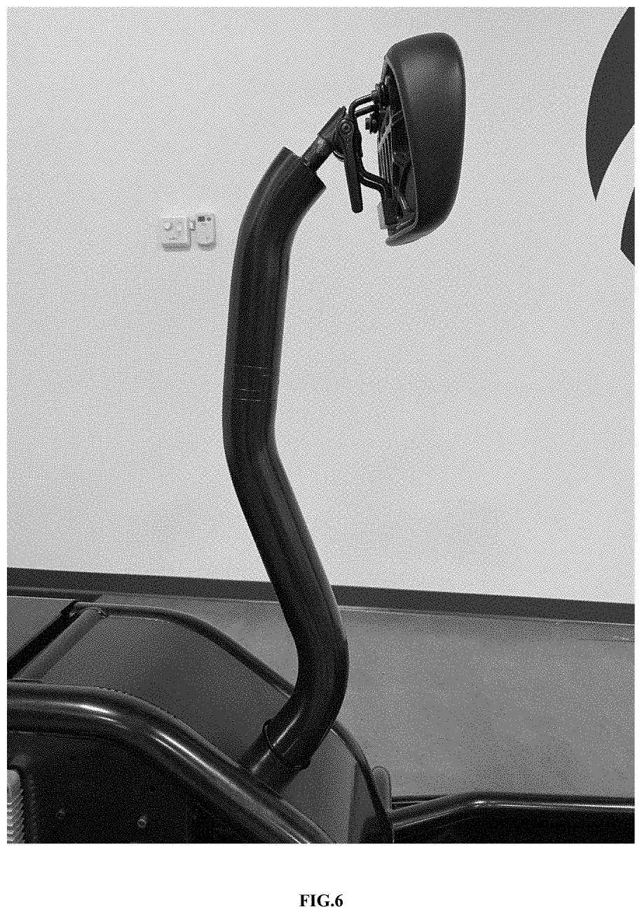

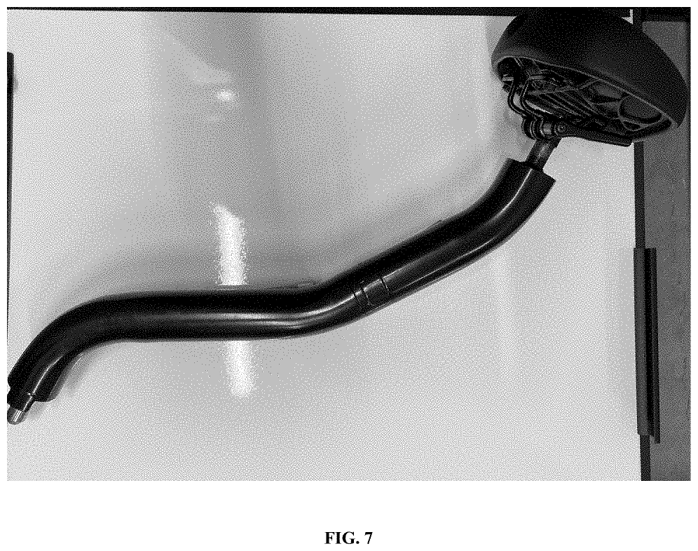

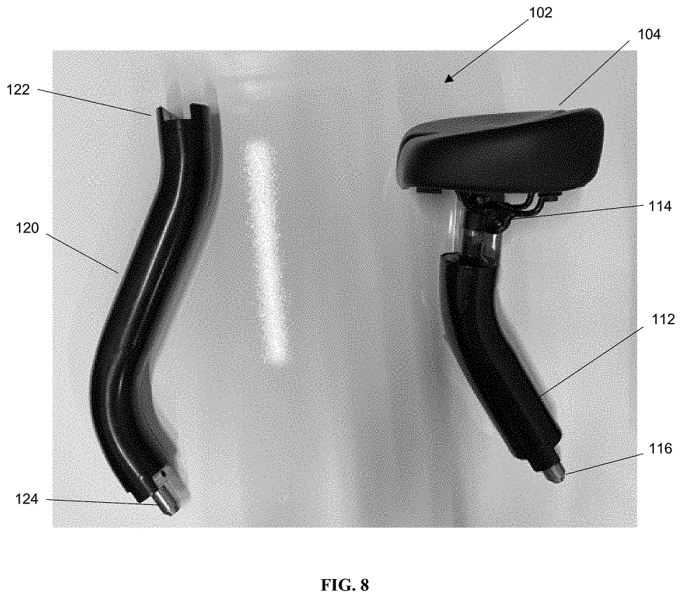

FIGS. 5 to 8 are photos of the seat post assembly. FIG. 5 is a photo of a seat post assembly in a motorized utility vehicle in sitting position. FIG. 6 is a photo of a seat post assembly in a motorized utility vehicle in standing position. FIG. 7 is a photo of an assembled seat post assembly. FIG. 8 is a photo of a disassembled seat post assembly.

According to FIG. 8, seat post assembly 102 is shown in a disassembled configuration. Seat post assembly 102 comprises of a top post member 112 and bottom post member 120. Top post member 112 comprises of seat 104 and handle/lever 114 and a male pin 116. Bottom post member 120 consists of receiving channel 122 and male pin 124. Receiving channel 122 of bottom post member 120 is configured to received male pin 116 of top post member 112 to complete assembled seat post assembly 102. Male pin 124 is configured to be threaded through seat frame 108 (not shown) or a frame post connector (not shown) of the utility vehicle.

According to FIG. 8, only top post member 112 is used to configure seat post assembly 102 in sitting position, whereas both top post member 112 and bottom post member 120 are assembled to create a longer seat post assembly 102 in standing position.

Seat post assembly 112 can be made of metal, aluminum or other types of materials such as ASTM A513 T5 DOM or AISI/SAE 4130. Seat post assembly 112 is substantially cylindrical in shape and has a diameter range of 1 inch to 3 inches. Male pin 116 and receiving channel 122 may be made of AISI 1018.

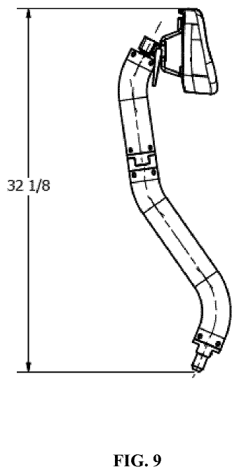

FIG. 9 is a side view of seat post assembly. According to FIG. 9, the top length of seat post assembly is 32⅛ inches, however other dimensions may be contemplated from a range of 24 inches to 36 inches.

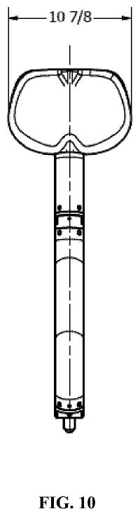

FIG. 10 is a front plan view of seat post assembly. According to FIG. 10, the seat width is approximately 10⅞ inches.

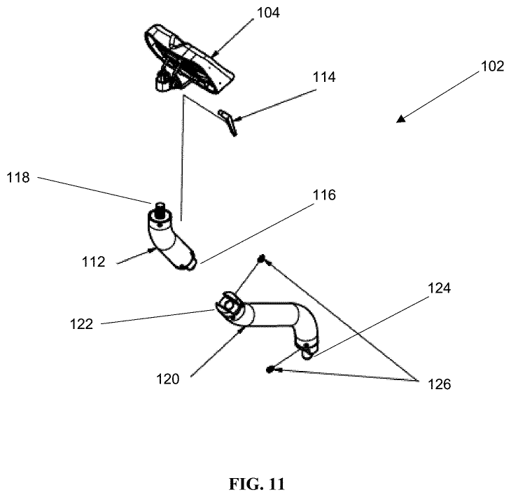

FIG. 11 is an exploded view of seat post assembly. Seat post assembly 102 consists of seat 104, seat handle 114, top post member 112, bottom post member 120, male pins 116, 118 and 124, receiving channel 122 and ball-nose spring plunger 126. According to FIG. 11, seat 104 may include a rail and clamp and may consist of CIONLLI #8077N. Seat handle 114 may be a low-profile handle such as MCMASTER #2832N15. Furthermore, ball-nose spring plunger 126 may consist of MCMASTER #3391A21. Ball-nose spring plunger 126 may also be made of such robust material as stainless steel.

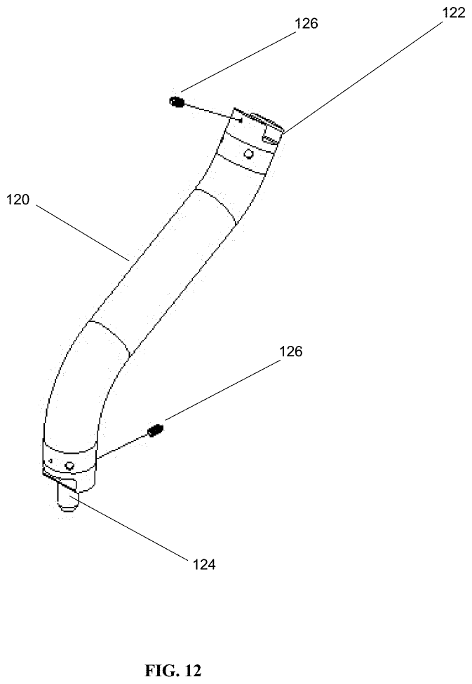

FIG. 12 is a perspective view of the bottom post member of the seat post assembly. According to FIG. 12, bottom post member 120 has a male pin 124 at the bottom and a substantially U-shaped receiving channel 122 at the top. Ball-nose spring plunger 126 may be received through holes near the receiving channel 122 at male pin 124.

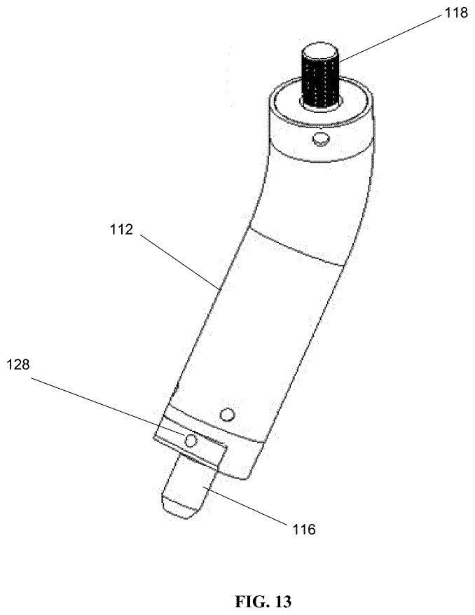

FIG. 13 is a perspective view of the top post member of the seat post assembly. According to FIG. 13, top post member 112 has a top male pin 118 and bottom male pin 116. In some embodiments, top male pin 118 male be threaded. Bottom male pin 116 has a receiving hole 128 to receive the ball-nose spring plunger 126 as shown in FIG. 12. Furthermore, bottom male pin 116 is shaped to provide a secure fit into receiving channel 122.

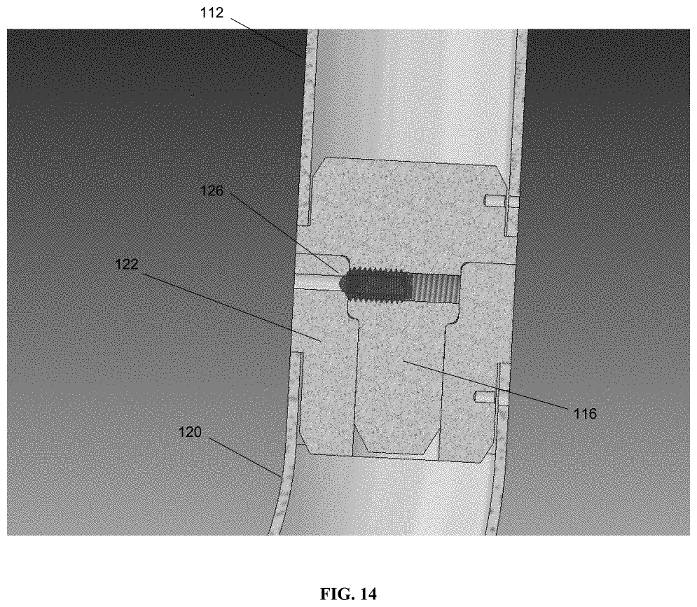

FIG. 14 is a cross-section view of a connection of top post member and bottom post member of the seat post assembly. According to FIG. 14, spring plunger 126 is threaded inside the male pin 116 and the receiving channel 122 of the top post member 112 and bottom post member 120. The spring plunger 126 will seat and aligned in a hole that is in the female receiver channel 122 which locks the parts together. Spring plunger 126 becomes a locking mechanism inside male pin 116. The female receiving channel 122 has a thru hole that receives the ball of the plunger which locks the entire assembly in place.

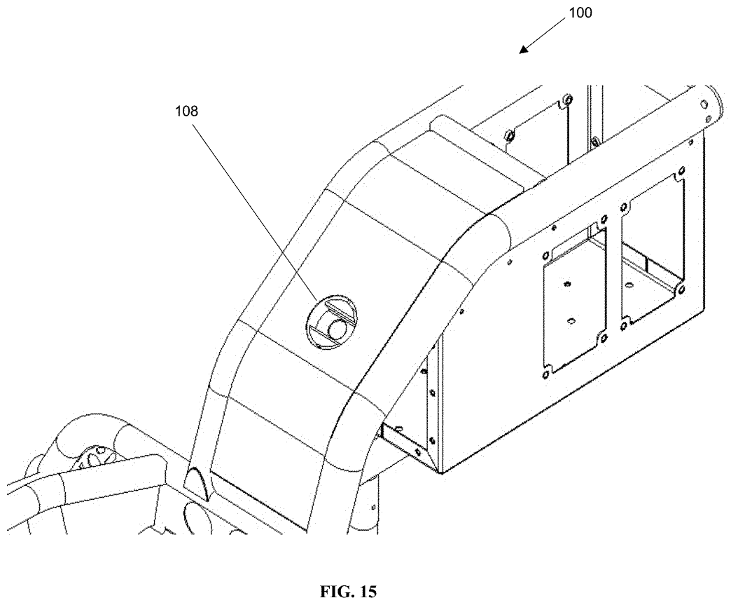

FIG. 15 is a line diagram of the connection of the seat post assembly to the standup motorized utility vehicle. According to FIG. 15, utility vehicle 100 has a seat frame connection channel 108. Seat frame connection channel 108 securely mates with the male pin 124 of bottom post member 120 and secured by spring plunger 16 as shown in FIG. 12 and FIG. 14.

According to the disclosure, to convert the back rest into a seat, the seat post assembly is disassembled. The top post member is attached to seat frame connection channel 108 of the utility vehicle 100. The top post member will be stored in a separate case (accessory) attached at the rear of the utility vehicle or can be stored by the rider in his/her garage if not in use.

According to embodiments of the disclosure, a removeable seat post assembly for use in a standup motorized utility vehicle is disclosed. The removeable seat post assembly comprises a substantially cylindrical top post member having a seat mount on one end a male pin on second end, a substantially cylindrical bottom post member having a receiving channel on top end and a male pin on second end, a pivotable seat connected to the seat mount of the cylindrical top post member and a receiving channel on the frame on the utility vehicle configured to receive the male pin of the top post member or the bottom post member. The top post member and bottom post member are configured to be assembled to form an “S” curvature shape seat post assembly and the seat post assembly is configured to support the rider in a standing position or a seated position.

According to the disclosure, the seat of the seat post assembly may be placed in a horizontal position in the seated position and in a vertical position in the standing position to support the back and spine of the rider. The seat post assembly further comprises a channel receiving hole on the receiving channel of the bottom post member and the frame of the utility vehicle.

According to the disclosure, the seat post assembly further comprises a substantially “n” shaped notch between the second end of the bottom post member and the bottom post member male pin and the second end of the top post member and the top post member male pin. The notch further comprises a notch receiving hole therethrough the substantially “n” shaped notch of the bottom post member and the notch of the top post member.

According to the disclosure, the seat post assembly further comprises a ball-nose spring plunger configured to be received in the channel receiving hole and the notch receiving hole to connect the male pin and receiving channel of the top post member and bottom post member and the bottom post member to the vehicle frame to securely lock the seat post assembly in place.

According to the disclosure, the seat post assembly further comprises a handle configured to pivot the seat at different angles and a seat belt configured to strap around the rider when the vehicle is in operation.

According to the disclosure, the length of the seat post assembly is selected from a range of 24 inches to 36 inches. The diameter of the cylindrical seat post assembly is selected from a range of 1 inch to 3 inches. The seat post assembly is made of materials selected from a list consisting of metal, aluminum, stainless steel, ASTM A513 T5 DOM or AISI/SAE 4130.

According to the disclosure, a motorized utility vehicle is enabled for operation by a standing rider. The vehicle consists of a frame, a motor housed within the frame, two front powered wheels connected to the frame, two rear powered wheels connected to the frame, a steering column connected to the frame, a handlebar connected to the distal end of the steering column and a seat post assembly configured to support the rider in a standing position and a sitting position. wherein the seat post assembly has an “S” curvature shape.

According to the disclosure, the seat post assembly of the motorized utility vehicle further comprises a top post member and a bottom post member configured to be assembled to form an “S” curvature shape seat post assembly. The top post member of the seat post assembly further comprises a seat on one end and a male pin on the second end. The bottom post member of the seat post further comprises a receiving channel on one end and a male pin on the second end.

According to the disclosure, the male pin of the top post member is configured to securely connect to the receiving channel of the bottom post member to form the assembled seat post assembly of the utility vehicle. Furthermore, the male pin of the top post member or the bottom post member is configured to be received into a receiving channel on the frame of the utility vehicle.

According to the disclosure, the utility vehicle further comprises a ball-nose spring plunger configured to be received in the receiving channel of the top post member and bottom post member and the bottom post member to the utility vehicle frame to securely lock the seat post assembly in place.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

What is claimed:

1. A removeable seat post assembly for use in a standup motorized utility vehicle, comprising:
a cylindrical top post member having a seat mount on one end a male pin on second end;
a cylindrical bottom post member having a receiving channel on top end and a male pin on second end;
a pivotable seat connected to the seat mount of the cylindrical top post member; and
a receiving channel on the frame on the utility vehicle configured to receive the male pin of the top post member or the bottom post member;
wherein the top post member and bottom post member are configured to be assembled to form an “S” curvature shape seat post assembly;
wherein the seat post assembly is configured to support the rider in a standing position or a seated position.

2. The seat post assembly of claim 1 wherein the seat is placed in a horizontal position in the seated position.

3. The seat post assembly of claim 1 wherein the seat is placed in a vertical position in the standing position to support the back and spine of the rider.

4. The seat post assembly of claim 1 further comprising a channel receiving hole on the receiving channel of the bottom post member and the frame of the utility vehicle.

5. The seat post assembly of claim 1 further comprising a substantially “n” shaped notch between the second end of the bottom post member and the bottom post member male pin and the second end of the top post member and the top post member male pin.

6. The seat post assembly of claim 5 further comprising a notch receiving hole therethrough the substantially “n” shaped notch of the bottom post member and the notch of the top post member.

7. The seat post assembly of claim 6 further comprising a ball-nose spring plunger configured to be received in the channel receiving hole and the notch receiving hole to connect the male pin and receiving channel of the top post member and bottom post member and the bottom post member to the vehicle frame to securely lock the seat post assembly in place.

8. The seat post assembly of claim 1 further comprising a handle configured to pivot the seat at different angles.

9. The seat post assembly of claim 1 further comprising a seat belt configured to strap around the rider when the vehicle is in operation.

10. The seat post assembly of claim 1 further comprising a seat belt configured to strap around the rider when the vehicle is in operation.

11. The seat post assembly of claim 1 wherein the length of the seat post assembly is selected from a range of 24 inches to 36 inches.

12. The seat post assembly of claim 1 wherein the diameter of the of the cylindrical seat post assembly is selected from a range of 1 inch to 3 inches.

13. The seat post assembly of claim 1 wherein the seat post assembly is made of materials selected from a list consisting of metal, aluminum, stainless steel, ASTM A513 T5 DOM or AISI/SAE 4130.

14. A motorized utility vehicle enabled for operation by a standing rider, the vehicle comprising:
a frame;
a motor housed within the frame;
two front powered wheels connected to the frame;
two rear powered wheels connected to the frame;
a steering column connected to the frame;
a handlebar connected to the distal end of the steering column; and
a seat post assembly configured to support the rider in a standing position and a sitting position;
wherein the seat post assembly has an “S” curvature shape.

15. The utility vehicle of claim 14 wherein the seat post assembly further comprises a top post member and a bottom post member configured to be assembled to form an “S” curvature shape seat post assembly.

16. The utility vehicle of claim 15 wherein the top post member of the seat post assembly further comprises a seat on one end and a male pin on the second end.

17. The utility vehicle of claim 15 wherein the bottom post member of the seat post further comprises a receiving channel on one end and a male pin on the second end.

18. The utility vehicle of claim 17 wherein the male pin of the top post member is configured to securely connect to the receiving channel of the bottom post member to form the assembled seat post assembly.

19. The utility vehicle of claim 17 wherein the male pin of the top post member or the bottom post member is configured to be received into a receiving channel on the frame of the utility vehicle.

20. The utility vehicle of claim 17 further comprising a ball-nose spring plunger configured to be received in the receiving channel of the top post member and bottom post member and the bottom post member to the utility vehicle frame to securely lock the seat post assembly in place.
